(19) United States
(12) Patent Application Publication
(10) Pub. No.: US 2023/0290938 A1
(43) Pub. Date: Sep. 14, 2023

(54) NEGATIVE ELECTRODE ACTIVE MATERIAL, NEGATIVE ELECTRODE AND LITHIUM-ION SECONDARY BATTERY

(71) Applicant: TDK CORPORATION, Tokyo (JP)

(72) Inventor: Kazuma AKIMOTO, Tokyo (JP)

(73) Assignee: TDK CORPORATION, Tokyo (JP)

(21) Appl. No.: 17/959,808

(22) Filed: Oct. 4, 2022

(30) Foreign Application Priority Data
Mar. 14, 2022 (JP) 2022-039708

(51) Int. Cl. H01M 4/38; H01M 10/0525

(52) U.S. Cl. CPC H01M 4/386; H01M 10/0525; H01M 2004/021

(57) ABSTRACT

The negative electrode active material contains silicon particles, and when an X-ray photoelectron spectroscopy spectrum with a binding energy in a range of 678 eV or more and 698 eV or less is measured from a surface in a depth direction, the X-ray photoelectron spectroscopy spectrum measured at any position in the depth direction has a first peak with a binding energy of 687 eV or more.

### BACKGROUND

### Field

The present invention relates to a negative electrode active material, a negative electrode and a lithium-ion secondary battery.

### Description of Related Art

Lithium-ion secondary batteries are also widely used as power sources for mobile devices such as cell phones and laptops and hybrid cars and the like.

The capacity of a lithium-ion secondary battery mainly depends on an active material of an electrode. Graphite is generally used as a negative electrode active material, but a negative electrode active material having a higher capacity is required. Therefore, silicon (Si), which has a much larger theoretical capacity than the theoretical capacity (372 mAh/g) of graphite, has been focused on. For example, Patent Document 1 describes a lithium-ion secondary battery having a high energy density using silicon as a negative electrode.

As the energy density of the lithium-ion secondary battery is higher, more attention should be paid to safety. For example, if heat is generated inside a lithium-ion secondary battery due to misuse, overcharging, internal short-circuiting or the like, problems such as decomposition of a non-aqueous electrolytic solution, and an increase in internal pressure may occur.

For example, Patent Document 2 describes that internal heat generation of a lithium-ion secondary battery can be minimized by providing an insulation member between a current collector and a mixture layer. In addition, for example, Patent Document 3 describes that the thermal stability is improved by adding an additive to an electrolytic solution and adjusting the void volume of each configuration.

### PATENT DOCUMENTS

[Patent Document 1] Japanese Unexamined Patent Application, First Publication No. 2020-181820
[Patent Document 2] Japanese Unexamined Patent Application, First Publication No. 2008-198591
[Patent Document 3] Japanese Unexamined Patent Application, First Publication No. 2016-9532

### SUMMARY

The above methods are not always available. Therefore, there is a demand for a configuration that can minimize excessive heat generation by another method not limited to these methods.

The present disclosure has been made in view of the above problem, and an object of the present disclosure is to provide a negative electrode active material, a negative electrode and a lithium-ion secondary battery which can minimize excessive heat generation.

In order to address the above problem, the following aspects are provided.
(1) A negative electrode active material according to a first aspect contains silicon particles, and when an X-ray photoelectron spectroscopy spectrum with a binding energy in a range of 678 eV or more and 698 eV or less is measured from a surface in a depth direction, the X-ray photoelectron spectroscopy spectrum measured at any position in the depth direction has a first peak with a binding energy of 687 eV or more.
(2) In the negative electrode active material according to the above aspect, the X-ray photoelectron spectroscopy spectrum measured at a depth position different from a depth position at which the first peak is measured may have a second peak at a position different from that of the first peak, and an energy difference between a binding energy of the first peak and a binding energy of the second peak may be 1 eV or more.
(3) A negative electrode according to a second aspect contains the negative electrode active material according to the above aspect.
(4) A lithium-ion secondary battery according to a third aspect includes the negative electrode according to the above aspect, a positive electrode, and an electrolyte that connects the positive electrode and the negative electrode.

The lithium-ion secondary battery according to the above aspect can minimize excessive heat generation.

### BRIEF DESCRIPTION OF THE DRAWINGS

FIG. 1 is a schematic cross-sectional view of a negative electrode active material according to a first embodiment.

FIG. 2 is an X-ray photoelectron spectroscopy spectrum of the negative electrode active material according to the first embodiment.

FIG. 3 is an X-ray photoelectron spectroscopy spectrum of the negative electrode active material according to the first embodiment.

FIG. 4 is a schematic cross-sectional view of a lithium-ion secondary battery according to the first embodiment.

### DETAILED DESCRIPTION

Hereinafter, embodiments will be described in detail with reference to the drawings as appropriate. In the drawing used in the following description, in order to facilitate understanding of features, feature parts are enlarged for convenience of illustration in some cases, and ratios between sizes and the like of components may be different from those of actual components. Materials, sizes and the like provided in the following description are exemplary examples, and the present invention is not limited thereto, and can be appropriately changed and implemented within ranges without changing the scope and spirit of the invention.

### “Negative Electrode Active Material”

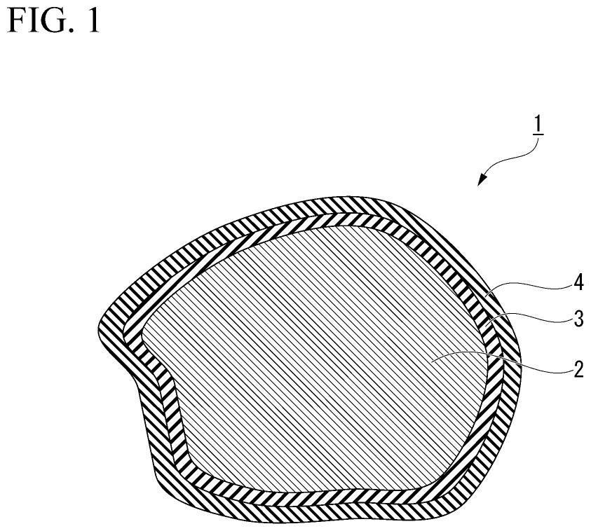

FIG. 1 is a schematic cross-sectional view of a negative electrode active material according to a first embodiment. A negative electrode active material 1 includes, for example, silicon particles 2, a surface layer 3, and a coating layer 4.

The silicon particles 2 may be a silicon alloy, a silicon compound, or a silicon complex in addition to elemental silicon. The silicon particles 2 may be crystalline or amorphous.

The silicon alloy is represented by, for example, XₙSi. X is a cation. X is, for example, Ba, Mg, Al, Zn, Sn, Ca, V, Cr, Mn, Fe, Co, Ni, Cu, Zn, Ge, Y, Zr, Nb, Mo, W, Au, Ti, Na, K or the like. n satisfies 0≤n≤0.5.

The silicon compound is, for example, silicon oxide represented by SiOₓ. x satisfies, for example, 0.8≤x≤2. Silicon oxide may be composed of SiO₂ alone, or SiO alone, or a mixture of SiO and SiO₂. In addition, silicon oxide may be partially deficient in oxygen.

The silicon complex is, for example, one in which at least a part of the surface of silicon or silicon compound particles is coated with a conductive material. Examples of conductive materials include a carbon material, Al, Ti, Fe, Ni, Cu, Zn, Ag, and Sn. For example, the silicon carbon composite material (Si—C) is an example of a complex.

The surface layer 3 is formed on at least a part of the surface of the silicon particles 2. The surface layer 3 is a part in which a peak shows at a position at which the binding energy is 687 eV or more when an X-ray photoelectron spectroscopy (XPS) spectrum with a binding energy in a range of 678 eV or more and 698 eV or less is measured from the surface in the depth direction. The XPS spectrum is an F1s spectrum. Hereinafter, the peak showed at a position at which the binding energy is 687 eV or more will be referred to as a first peak. The first peak shows, for example, at a position at which the binding energy is 687 eV or more and 690 eV or less.

In the surface layer 3, silicon and fluorine are bonded. The surface layer 3 is formed by treating the surface of silicon particles 2 with fluorine in advance.

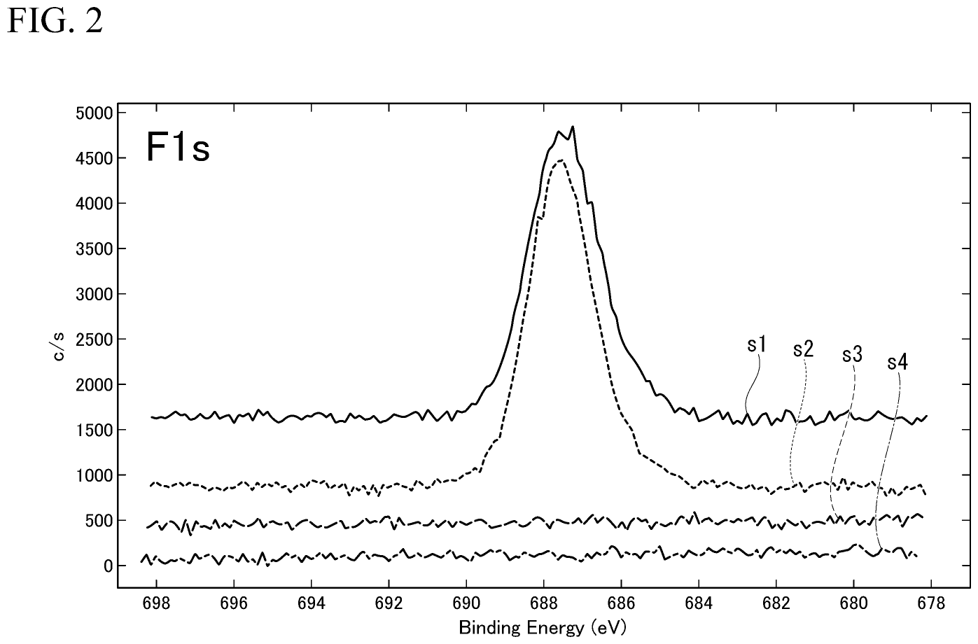

FIG. 2 is an X-ray photoelectron spectroscopy (XPS) spectrum of the negative electrode active material according to the first embodiment. The XPS spectrum shown in FIG. 2 is obtained by measuring the XPS spectrum with a binding energy in a range of at least 678 eV or more and 698 eV or less from the surface of the negative electrode active material 1 in the depth direction through X-ray photoelectron spectroscopy. FIG. 2 shows the measurement results of the negative electrode active material 1 according to the first embodiment in which the surface of silicon particles 2 is treated with fluorine and the measurement results of the negative electrode active material not treated with fluorine. Samples s1 and s2 are the measurement results of the negative electrode active material 1 according to the first embodiment in which the surface of silicon particles 2 is treated with fluorine. Samples s3 and s4 are the measurement results of the negative electrode active material not treated with fluorine.

As shown in FIG. 2, in the XPS spectrum of Samples s1 and s2, the first peak is confirmed. On the other hand, in the XPS spectrum of Samples s3 and 4, the first peak is not confirmed. The first peak is considered to be a peak derived from the bond between silicon and fluorine by a fluorine treatment of the silicon particles 2.

The coating layer 4 is formed to cover at least a part of the silicon particles 2 or the surface layer 3. The coating layer 4 is a part in which a peak occurs at a position different from that of the first peak when the XPS spectrum with a binding energy in a range of 678 eV or more and 698 eV or less is measured from the surface in the depth direction. Hereinafter, this peak will be referred to as a second peak. The second peak occurs at a position at which the binding energy is less than 687 eV, for example, at a position at which the binding energy is 685 eV or more and 686 eV or less. The energy difference between the binding energy of the first peak and the binding energy of the second peak is, for example, 1 eV or more.

In the negative electrode active material 1, the coating layer 4 is outside the surface layer 3. When X-ray photoelectron spectroscopy is performed while performing etching from the surface of the negative electrode active material 1 in the depth direction, the second peak is detected in the XPS spectrum at a position dug to a certain depth, and subsequently, the first peak is detected in the XPS spectrum at a position at which additional etching is performed.

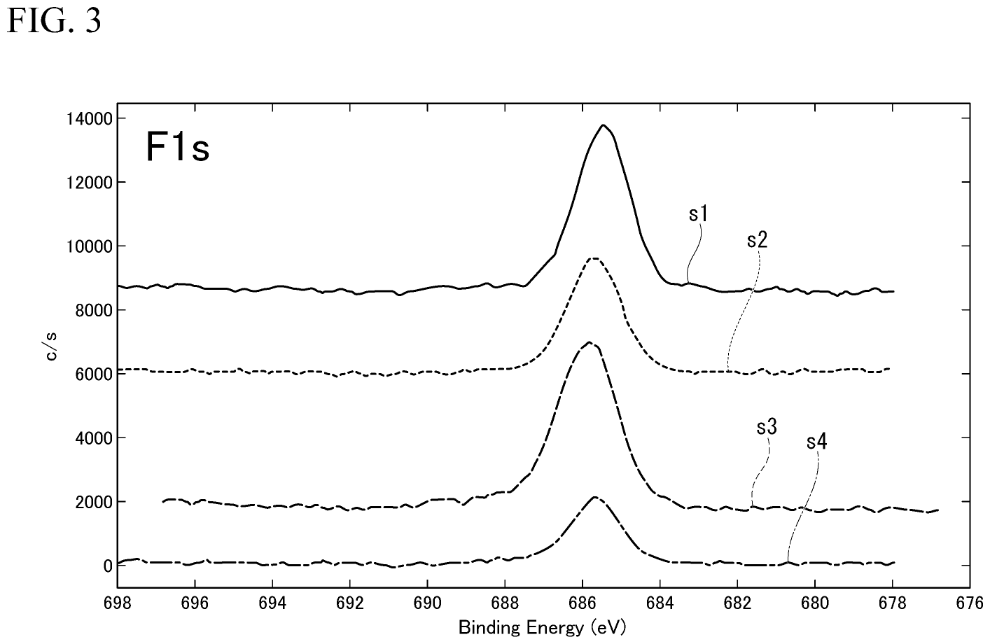

FIG. 3 is the X-ray photoelectron spectroscopy (XPS) spectrum of the negative electrode active material according to the first embodiment. The XPS spectrum shown in FIG. 3 is obtained by measuring the XPS spectrum with a binding energy in a range of at least 678 eV or more and 698 eV or less from the surface of the negative electrode active material 1 in the depth direction through X-ray photoelectron spectroscopy. FIG. 3 shows the measurement results of the negative electrode active material 1 according to the first embodiment in which the surface of the silicon particles 2 is treated with fluorine and the measurement results of the negative electrode active material not treated with fluorine. Samples s1 and s2 are the measurement results of the negative electrode active material 1 according to the first embodiment in which the surface of the silicon particles 2 is treated with fluorine. Samples s3 and s4 are the measurement results of the negative electrode active material not treated with fluorine.

As shown in FIG. 3, the second peak is confirmed in the XPS spectrum of any of Samples s1 to s4. The second peak is considered to be a peak derived from fluorine contained in a solid electrolyte interphase (SEI) coating. The SEI coating is a stable coating formed in the initial stage of use of the lithium-ion secondary battery. The SEI coating prevents direct contact between the negative electrode active material and the electrolytic solution, and prevents decomposition of the electrolytic solution.

The average particle size of the negative electrode active material 1 is, for example, 0.1 μm or more and 10 μm or less, preferably 0.5 μm or more and 8 μm or less, and more preferably 1 μm or more and 7 μm or less.

When the negative electrode active material 1 in the form of particles is available, the median diameter (D50) can be determined as an average particle size using a particle size distribution measuring device (for example, commercially available from Malvern Panalytical). When the particle size distribution measuring device is used, for example, the average particle size of 50,000 particles is obtained. When the negative electrode active material 1 is within the electrode and it is difficult to separate the negative electrode active material 1 from the electrode, the average particle size can be obtained using at least 100 negative electrode active materials 1 confirmed in the cross-sectional image.

The negative electrode active material 1 according to the first embodiment can be produced by producing silicon particles 2 and then treating the surface of the silicon particles 2 with fluorine.

The silicon particles 2 can be produced by a known method. As the silicon particles 2, a commercially available product may be purchased.

Next, a fluorine treatment is performed. For example, the silicon particles 2 are put into a container and treated with plasma in fluorine gas, and thus the silicon particles 2 are treated with fluorine. In addition, the silicon particles 2 may be immersed in hydrofluoric acid. According to immersion in hydrofluoric acid, the surface of the silicon particles 2 is etched, and also treated with fluorine. According to the fluorine treatment, the surface layer 3 is formed. The coating layer 4 is formed during charging and discharging at the initial stage of use of the lithium-ion secondary battery.

Since the surface of the negative electrode active material 1 according to the first embodiment is treated with fluorine in advance, it is possible to minimize excessive heat generation of the lithium-ion secondary battery.

For example, when an abnormality such as internal short-circuiting occurs in the lithium-ion secondary battery, heat is generated, and the reaction between silicon and fluorine in the electrolytic solution is promoted. When silicon reacts with fluorine in the electrolytic solution, a stable coating is formed, but heat is additionally generated when the coating is formed. That is, heat generated due to internal short-circuiting is enhanced by heat generated when the coating is formed.

On the other hand, since the surface of the negative electrode active material 1 according to the first embodiment is treated with fluorine, it is possible to reduce the amount of heat generated when silicon reacts with fluorine in the electrolytic solution, and minimize excessive heat generation.

### “Lithium-Ion Secondary Battery”

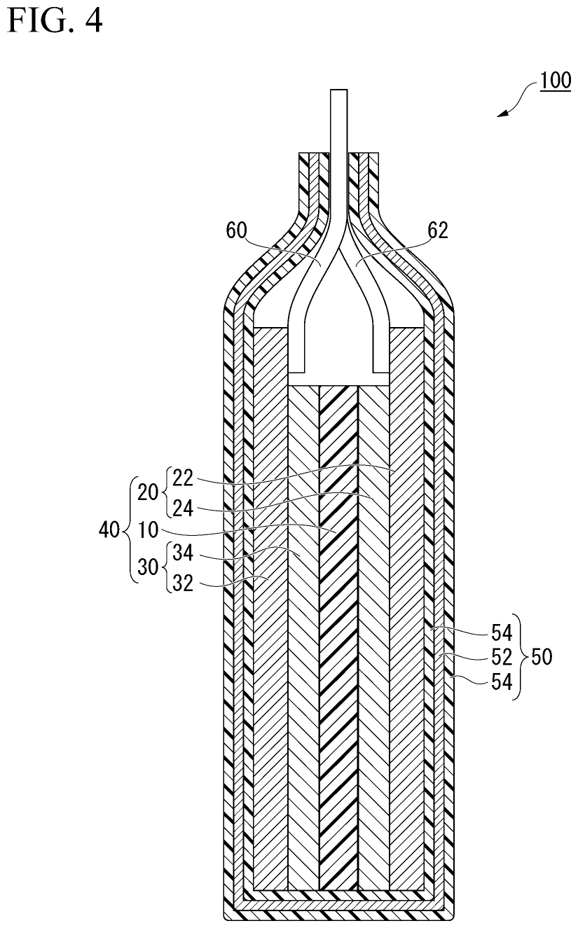

FIG. 4 is a schematic view of the lithium-ion secondary battery according to the first embodiment. A lithium-ion secondary battery 100 shown in FIG. 4 includes a power generation element 40, an exterior body 50, and an electrolyte (for example, a non-aqueous electrolytic solution). The exterior body 50 covers the periphery of the power generation element 40. The power generation element 40 is connected to the outside by a pair of connected terminals 60 and 62. The non-aqueous electrolytic solution is accommodated in the exterior body 50. In FIG. 4, a case in which one power generation element 40 is provided in the exterior body 50 is illustrated, but a plurality of power generation elements 40 may be laminated.

### (Power Generation Element)

The power generation element 40 includes a separator 10, a positive electrode 20 and a negative electrode 30. The power generation element 40 may be a laminate in which the above components are laminated or a wound body in which a structure obtained by laminating the above components is wound.

### <Positive Electrode>

The positive electrode 20 has, for example, a positive electrode current collector 22 and a positive electrode active material layer 24. The positive electrode active material layer 24 comes in contact with at least one surface of the positive electrode current collector 22.

### [Positive Electrode Current Collector]

The positive electrode current collector 22 is, for example, a conductive plate material. The positive electrode current collector 22 is, for example, a thin metal plate of aluminum, copper, nickel, titanium, stainless steel or the like. Light-weight aluminum is suitably used for the positive electrode current collector 22. The average thickness of the positive electrode current collector 22 is, for example, 10 μm or more and 30 μm or less.

### [Positive Electrode Active Material Layer]

The positive electrode active material layer 24 contains, for example, a positive electrode active material. The positive electrode active material layer 24 may contain, as necessary, a conductive additive and a binder.

The positive electrode active material includes an electrode active material that can reversibly perform occlusion and release of lithium ions, separation and insertion (intercalation) of lithium ions or doping and dedoping of lithium ions and counter anions.

The positive electrode active material is, for example, a composite metal oxide. Examples of composite metal oxides include lithium cobalt oxide (LiCoO₂), lithium nickel oxide (LiNiO₂), lithium manganate (LiMnO₂), lithium manganese spinel (LiMn₂O₄), and a compound represented by a general formula: LiNiₓCo_{y}Mn_{z}MₐO₂ (in the general formula, x+y+z+a=1, 0≤x<1, 0≤y<1, 0≤z<1, 0≤a<1, and M represents one or more elements selected from among Al, Mg, Nb, Ti, Cu, Zn, and Cr), a lithium vanadium compound (LiV₂O₅), an olivine-type LiMPO₄ (where, M represents one or more elements selected from among Co, Ni, Mn, Fe, Mg, Nb, Ti, Al, and Zr or VO), lithium titanate (Li₄Ti₅O₁₂), and LiNiₓCo_{y}Al_{z}O₂ (0.9<x+y+z<1.1). The positive electrode active material may be an organic substance. For example, the positive electrode active material may be polyacetylene, polyaniline, polypyrrole, polythiophene, or polyacene.

The positive electrode active material may be a lithium-free material. Examples of lithium-free materials include FeF₃, a conjugated polymer containing an organic conductive material, a Chevrel phase compound, a transition metal chalcogenide, vanadium oxide, and niobium oxide. As the lithium-free material, one of the materials may be used alone, or a plurality of materials may be used in combination. When the positive electrode active material is a lithium-free material, for example, discharging is performed first. Lithium is inserted into the positive electrode active material by discharging. In addition, lithium may be chemically or electrochemically pre-doped into a lithium-free material as the positive electrode active material.

The conductive additive improves electron conductivity between positive electrode active materials. Examples of conductive additives include a carbon powder, a carbon nanotube, a carbon material, a fine metal powder, a mixture of a carbon material and a fine metal powder, and a conductive oxide. Examples of carbon powders include carbon black, acetylene black, and ketjen black. Examples of fine metal powders include copper, nickel, stainless steel, and iron powders.

The amount of the conductive additive in the positive electrode active material layer 24 is not particularly limited. For example, the amount of the conductive additive with respect to a total mass of the positive electrode active material, the conductive additive, and the binder is 0.5 mass % or more and 20 mass % or less, and preferably 1 mass % or more and 5 mass % or less.

The binder in the positive electrode active material layer 24 binds positive electrode active materials to each other. A known binder can be used. The binder is preferably one that is not dissolved in the electrolytic solution, has oxidation resistance, and has adhesiveness. The binder is, for example, a fluorine resin. Examples of binders include polyvinylidene fluoride (PVDF), polyvinyl alcohol (PVA), polytetrafluoroethylene (PTFE), polyamide (PA), polyimide (PI), polyamide imide (PAI), polybenzimidazole (PBI), polyether sulfone (PES), polyacrylic acid and its copolymer, a metal ion crosslinked product of polyacrylic acid and its copolymer, and polypropylene (PP) or polyethylene (PE) grafted with maleic anhydride, and a mixture thereof. The binder used for the positive electrode active material layer is particularly preferably PVDF.

The amount of the binder in the positive electrode active material layer 24 is not particularly limited. For example, the amount of the binder with respect to a total mass of the positive electrode active material, the conductive additive, and the binder is 1 mass % or more and 15 mass % or less, and preferably 1.5 mass % or more and 5 mass % or less. When the amount of the binder is small, the adhesive strength of the positive electrode 20 is weakened. When the amount of the binder is large, since the binder is electrochemically inactive and does not contribute to the discharging capacity, the energy density of the lithium-ion secondary battery 100 becomes low.

### <Negative Electrode>

The negative electrode 30 has, for example, a negative electrode current collector 32 and a negative electrode active material layer 34. The negative electrode active material layer 34 is formed on at least one surface of the negative electrode current collector 32.

### [Negative Electrode Current Collector]

The negative electrode current collector 32 is, for example, a conductive plate material. As the negative electrode current collector 32, the same current collector as the positive electrode current collector 22 can be used.

### [Negative Electrode Active Material Layer]

The negative electrode active material layer 34 contains a negative electrode active material and a binder. The negative electrode active material layer may contain, as necessary, a conductive additive, a dispersion stabilizer and the like. As the negative electrode active material, the above negative electrode active material is used.

As the conductive additive and the binder, the same ones as in the positive electrode 20 can be used. The binder in the negative electrode 30 may be, for example, cellulose, styrene-butadiene rubber, ethylene-propylene rubber, a polyimide resin, a polyamide imide resin, an acrylic resin or the like, in addition to those listed in the positive electrode 20. The cellulose may be, for example, carboxymethyl cellulose (CMC).

### <Separator>

The separator 10 is interposed between the positive electrode 20 and the negative electrode 30. The separator 10 separates the positive electrode 20 and the negative electrode 30, and prevents short circuiting between the positive electrode 20 and the negative electrode 30. The separator 10 extends in-plane along the positive electrode 20 and the negative electrode 30. Lithium ions can pass through the separator 10.

The separator 10 has, for example, an electrically insulating porous structure. The separator 10 is, for example, a single layer film or a laminate made of polyolefin. The separator 10 may be a stretched film of a mixture of polyethylene, polypropylene and the like. The separator 10 may be a fibrous non-woven fabric made of at least one constituent material selected from the group consisting of cellulose, polyester, polyacrylonitrile, polyamide, polyethylene and polypropylene. The separator 10 may be, for example, a solid electrolyte. The solid electrolyte is, for example, a polymer solid electrolyte, an oxide-based solid electrolyte, or a sulfide-based solid electrolyte. The separator 10 may be an inorganic coated separator. The inorganic coated separator is obtained by applying a mixture of a resin such as PVDF or CMC and an inorganic substance such as alumina or silica onto the surface of the film. The inorganic coated separator has excellent heat resistance, and minimizes precipitation of transition metals eluted from the positive electrode on the surface of the negative electrode.

### <Electrolytic Solution>

The electrolytic solution is enclosed in the exterior body 50, and impregnated into the power generation element 40. The electrolytic solution is not limited to a liquid electrolyte, and may be a solid electrolyte. The non-aqueous electrolytic solution contains, for example, a non-aqueous solvent and an electrolytic salt. The electrolytic salt is dissolved in a non-aqueous solvent.

The solvent is not particularly limited as long as it is a solvent that is generally used for a lithium-ion secondary battery. The solvent contains, for example, any of a cyclic carbonate compound, a chain carbonate compound, a cyclic ester compound, and a chain ester compound. The solvent may contain a mixture of these components at a certain ratio. Examples of cyclic carbonate compounds include ethylene carbonate (EC), propylene carbonate (PC), fluoroethylene carbonate, and vinylene carbonate. Examples of chain carbonate compounds include diethyl carbonate (DEC) and ethyl methyl carbonate (EMC). Examples of cyclic ester compounds include γ-butyrolactone. Examples of chain ester compounds include propyl propionate, ethyl propionate, and ethyl acetate.

The electrolytic salt is, for example, a lithium salt. Examples of electrolytes include LiPF₆, LiClO₄, LiBF₄, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO₂), LiN(CF₃CF₂CO)₂, LiBOB, and LiN(FSO₂)₂. The lithium salts may be used alone or two or more thereof may be used in combination. In consideration of the degree of ionization, the electrolyte preferably contains LiPF₆. The degree of divergence of the electrolytic salt in the carbonate solvent at room temperature is preferably 10% or more.

The electrolytic solution is preferably, for example, one in which LiPF₆ is dissolved in a carbonate solvent. The concentration of LiPF₆ is, for example, 1 mol/L. When the polyimide resin contains a large amount of an aromatic compound, the polyimide resin may exhibit a charging behavior similar to that of soft carbon. When the electrolytic solution is a carbonate electrolyte solvent containing a cyclic carbonate, lithium can be uniformly reacted with a polyimide. In this case, the cyclic carbonate is preferably ethylene carbonate, fluoroethylene carbonate, or vinylene carbonate.

### <Exterior Body>

The exterior body 50 seals the power generation element 40 and a non-aqueous electrolytic solution therein. The exterior body 50 prevents a non-aqueous electrolytic solution from leaking to the outside and water and the like from entering the inside of the lithium-ion secondary battery 100 from the outside.

For example, as shown in FIG. 4, the exterior body 50 has a metal foil 52, and a resin layer 54 laminated on each surface of the metal foil 52. The exterior body 50 is a metal laminate film in which the metal foil 52 is coated with a polymer film (the resin layer 54) from both sides.

As the metal foil 52, for example, an aluminum foil can be used. A polymer film such as polypropylene can be used for the resin layer 54. The material constituting the resin layer 54 may be different between the inside and the outside. For example, a polymer having a high melting point, for example, polyethylene terephthalate (PET), polyamide (PA) or the like can be used as the outer material, and polyethylene (PE), polypropylene (PP) or the like can be used as the material of the inner polymer film.

### <Terminal>

The terminals 60 and 62 are connected to the negative electrode 30 and the positive electrode 20, respectively. The terminal 60 connected to the positive electrode 20 is a positive electrode terminal, and the terminal 62 connected to the negative electrode 30 is a negative electrode terminal. The terminals 60 and 62 are responsible for electrical connection with the outside. The terminals 60 and 62 are formed of a conductive material such as aluminum, nickel, copper or the like. The connection method may be welding or screwing. In order to prevent short circuiting, it is preferable to protect the terminals 60 and 62 with an insulation tape.

The lithium-ion secondary battery 100 is produced by preparing the negative electrode 30, the positive electrode 20, the separator 10, an electrolytic solution, and the exterior body 50 and combining them. Hereinafter, an example of a method of producing the lithium-ion secondary battery 100 will be described.

The negative electrode 30 is produced by performing, for example, a slurry producing step, an electrode coating step, a drying step, and a rolling step in this order.

The slurry producing step is a step of mixing a negative electrode active material, a binder, a conductive additive and a solvent to prepare a slurry. The negative electrode active material is silicon treated with fluorine. When a dispersion stabilizer is added to the slurry, it is possible to minimize aggregation of the negative electrode active material.

The slurry producing step is a step of mixing a negative electrode active material, a binder, a conductive additive and a solvent to prepare a slurry. Examples of solvents include water and N-methyl-2-pyrrolidone.

The electrode coating step is a step of applying the slurry onto the surface of the negative electrode current collector 32. The slurry applying method is not particularly limited. For example, a slit die coating method or a doctor blade method can be used as the slurry applying method. The slurry is applied, for example, at room temperature.

The drying step is a step of removing the solvent from the slurry. For example, the negative electrode current collector 32 coated with the slurry is dried in an atmosphere at 80° C. to 350° C.

The rolling step is performed as necessary. The rolling step is a step of applying pressure to the negative electrode active material layer 34 and adjusting the density of the negative electrode active material layer 34. The rolling step is performed by, for example, a roll press device or the like.

The positive electrode 20 can be produced in the same procedure as in the negative electrode 30. As the separator 10 and the exterior body 50, commercially available products can be used.

Next, the power generation element 40 is produced by laminating the produced positive electrode 20 and negative electrode 30 so that the separator 10 is positioned therebetween. When the power generation element 40 is a wound body, the positive electrode 20, the negative electrode 30 and the separator 10 are wound around one end side as an axis.

Finally, the power generation element 40 is enclosed in the exterior body 50. The non-aqueous electrolytic solution is injected into the exterior body 50. When the pressure is reduced, heating or the like is performed after the non-aqueous electrolytic solution is injected, the non-aqueous electrolytic solution is impregnated into the power generation element 40. When the exterior body 50 is sealed by applying heat or the like, the lithium-ion secondary battery 100 is obtained. Here, instead of injecting the electrolytic solution into the exterior body 50, the power generation element 40 may be impregnated into the electrolytic solution. After the liquid is injected into the power generation element, it is preferable to leave it for 24 hours.

Since the lithium-ion secondary battery 100 according to the first embodiment contains a predetermined negative electrode active material, it is highly safe even when internal short-circuiting occurs due to an impact or the like.

The embodiments of the present invention have been described in detail above with reference to the drawings, and configurations and combinations thereof in the embodiments are only examples, and additions, omissions, substitutions and other modifications of the configurations can be made without departing from the spirit and scope of the present invention.

### EXAMPLES

### Example 1

A positive electrode slurry was applied onto one surface of an aluminum foil having a thickness of 15 μm. The positive electrode slurry was produced by mixing a positive electrode active material, a conductive additive, a binder and a solvent.

LiₓCoO₂ was used as the positive electrode active material. Acetylene black was used as the conductive additive. Polyvinylidene fluoride (PVDF) was used as the binder. N-methyl-2-pyrrolidone was used as the solvent. A positive electrode slurry was produced by mixing 97 parts by mass of the positive electrode active material, 1 part by mass of the conductive additive, 2 parts by mass of the binder, and 70 parts by mass of the solvent. The amount of the positive electrode active material supported on the positive electrode active material layer after drying was 25 mg/cm². The solvent was removed from the positive electrode slurry in a drying furnace to prepare a positive electrode active material layer. The positive electrode active material layer was pressurized with a roll press to produce a positive electrode.

Next, silicon particles having an average particle size of 3.7 μm were put into a container and treated with plasma in fluorine gas. The treatment time for this fluorine treatment was 60 minutes. Then, a negative electrode slurry was produced using the silicon particles after the fluorine treatment. Carbon black was used as the conductive additive. A polyimide resin was used as the binder. N-methyl-2-pyrrolidone was used as the solvent. A negative electrode slurry was produced by mixing 90 parts by mass of the fluorine-treated silicon particles, 5 parts by mass of the conductive additive, 5 parts by mass of the binder, and N-methyl-2-pyrrolidone.

Then, regarding the slurry, the negative electrode slurry was applied onto one surface of a copper foil having a thickness 10 μm and dried it. The amount of the negative electrode active material supported on the negative electrode active material layer after drying was 2.5 mg/cm². The negative electrode active material layer was pressurized with a roll press and then fired under a nitrogen atmosphere at 300° C. or higher for 5 hours.

Next, an electrolytic solution was produced. The solvent of the electrolytic solution contained fluoroethylene carbonate (FEC):ethylene carbonate (EC):diethyl carbonate (DEC)=10 volume %:20 volume %:70 volume %. In addition, an output-improving additive, a gas-minimizing additive, a cycle-characteristic-improving additive, a safe-performance-improving additive and the like were added to the electrolytic solution. LiPF₆ was used as the electrolytic salt. The concentration of LiPF₆ was 1 mol/L.

### (Production of Lithium-Ion Secondary Battery for Evaluation)

The produced negative electrode and positive electrode were laminated with a separator (porous polyethylene sheet) therebetween so that the positive electrode active material layer and the negative electrode active material layer faced each other to obtain a laminate. This laminate was inserted into the exterior body of the aluminum laminated film and heat-sealed except for one peripheral part to form a closed part. Then, finally, the electrolytic solution was injected into the exterior body and the remaining one part was then sealed with a heat seal while the pressure was reduced by a vacuum sealing machine to produce a lithium-ion secondary battery. The produced lithium-ion secondary battery was left for 24 hours.

### (Nail Penetration Test)

A nail penetration test was performed using the produced lithium-ion secondary battery. First, the lithium-ion secondary battery was charged. Charging was performed under an environment at 25° C. by constant current charging at a charging rate of 1.0C (a current value at which charging was completed in 1 hour when constant current charging was performed at 25° C.) until the battery voltage reached 4.4 V. Then, a nail having a diameter of 2.5 mm was stuck into the charged battery at a speed of 150 mm/s and the nail penetration test was performed. Then, the surface temperature of the lithium-ion secondary battery after nail penetration was measured. The surface temperature of the lithium-ion secondary battery of Example 1 was 27° C.

### (XPS Measurement)

In addition, the lithium-ion secondary battery produced under the same conditions was subjected to constant current and constant voltage charging at 0.5C up to 4.2 V, subjected to constant current discharging at 1C up to 2.8 V, and the negative electrode was then taken out, and XPS analysis was performed. For the XPS analysis, measurement was performed while etching was performed from the surface of the negative electrode active material in the depth direction. For the XPS analysis, measurement was performed using Quantera2 (commercially available from PHI).

In the negative electrode active material according to Example 1, in the XPS spectrum measured near the surface, a peak was confirmed at a position with a binding energy of 686 eV. In addition, in the negative electrode active material according to Example 1, in the XPS spectrum measured at a position obtained by etching by 40 nm from the surface, a peak was confirmed at a position with a binding energy of 688 eV. That is, when the X-ray photoelectron spectroscopy spectrum with a binding energy in a range of 678 eV or more and 698 eV or less was measured from the surface in the depth direction, two peaks were confirmed. The energy difference between the two peaks was 2 eV.

### Examples 2 and 3

Examples 2 and 3 were different from Example 1 in that conditions for treating silicon particles with fluorine were changed. Specifically, in Example 2, the treatment time for the fluorine treatment was 30 minutes, and in Example 3, the fluorine treatment was changed to 45 minutes. The other conditions were the same as in Example 1, and evaluation was performed.

### Example 4

Example 4 was different from Example 2 in that initial charging and discharging conditions were changed. Example 4 was different from Example 2 in that initial charging and discharging were performed under an environment at 45° C., and the coating structure was changed. The other conditions were the same as in Example 2, and evaluation was performed.

### Comparative Example 1 and Comparative Example 2

Comparative Example 1 and Comparative Example 2 were different from Example 1 in that they were not treated with fluorine. The other conditions were the same as in Example 1, and evaluation was performed. Initial charging and discharging conditions were different between Comparative Example 1 and Comparative Example 2, and in Comparative Example 2, fluorine bonds in two different states were mixed in the coating layer.

The following Table 1 summarizes the results of Examples 1 to 4, Comparative Example 1 and Comparative Example 2. The “maximum binding energy” in Table 1 is the position of the peak top of the peak having the largest binding energy among the peaks confirmed in the range in which the binding energy is 678 eV or more and 698 eV or less. The “number of peaks” is the number of peaks confirmed in the range in which the binding energy is 678 eV or more and 698 eV or less. The “binding energy difference” is a binding energy difference between the peak of the maximum energy and the peak of the minimum energy confirmed in the range in which the binding energy is 678 eV or more and 698 eV or less. The “nail penetration test temperature” is the surface temperature of the lithium-ion secondary battery after the nail penetration test.

TABLE 1

| | Maximum | | Binding | Nail |
|---|---|---|---|---|
| | binding | | energy | penetration test |
| | energy | Number | difference | temperature |
| | (eV) | of peaks | (eV) | (° C.) |
| Example 1 | 688 | 2 | 2 | 27 |
| Example 2 | 687 | 2 | 1 | 40 |
| Example 3 | 687 | 2 | 0.9 | 45 |
| Example 4 | 687 | 2 | 2 | 30 |
| Comparative | 686 | 1 | — | 150 |
| Example 1 | | | | |
| Comparative | 686 | 2 | 1 | 125 |
| Example 2 | | | | |

In Examples 1 to 4, the surface temperature after the nail penetration test was lower than that of Comparative Examples 1 and 2. In Examples 1 to 4, it was considered that, since the silicon surface was treated with fluorine, the reaction between silicon and fluorine in the electrolytic solution could be inhibited.

### EXPLANATION OF REFERENCES

1 Negative electrode active material
2 Silicon particles
3 Surface layer
4 Coating layer
10 Separator
20 Positive electrode
22 Positive electrode current collector
24 Positive electrode active material layer
30 Negative electrode
32 Negative electrode current collector
34 Negative electrode active material layer
40 Power generation element
50 Exterior body
52 Metal foil
54 Resin layer
60, 62 Terminal
100 Lithium-ion secondary battery

What is claimed is:

1. A negative electrode active material, comprising
silicon particles,
wherein, when an X-ray photoelectron spectroscopy spectrum with a binding energy in a range of 678 eV or more and 698 eV or less is measured from a surface in a depth direction,
the X-ray photoelectron spectroscopy spectrum measured at any position in the depth direction has a first peak with a binding energy of 687 eV or more.

2. The negative electrode active material according to claim 1,
wherein the X-ray photoelectron spectroscopy spectrum measured at a depth position different from a depth position at which the first peak is measured has a second peak at a position different from that of the first peak, and
wherein an energy difference between a binding energy of the first peak and a binding energy of the second peak is 1 eV or more.

3. A negative electrode comprising the negative electrode active material according to claim 1.

4. A lithium-ion secondary battery, comprising
the negative electrode according to claim 3, a positive electrode that faces the negative electrode, and an electrolyte that connects the negative electrode and the positive electrode.
